(19) United States
(12) Patent Application Publication
(10) Pub. No.: US 2008/0122770 A1
(43) Pub. Date: May 29, 2008

(54) Display panel and electronic system utilizing the same

(75) Inventors: Sheng-Feng Huang, Miaoli City (TW); I-Chun Lai, Taiping City (TW)

Correspondence Address: LIU & LIU, 444 S. FLOWER STREET, SUITE 1750, LOS ANGELES, CA, 90071, US

(73) Assignee: TPO Displays Corp.

(21) Appl. No.: 11/983,496

(22) Filed: Nov. 9, 2007

(30) Foreign Application Priority Data
Nov. 29, 2006 (TW) 095144202

(51) Int. Cl. G09G 3/36

(52) U.S. Cl. 345/87

(57) ABSTRACT

A display panel including a first sub-pixel, a second sub-pixel, a third sub-pixel, and a first capacitor is disclosed. The first sub-pixel is coupled to a first gate line. The second sub-pixel is coupled to a second gate line. The third sub-pixel is coupled to the second gate line. The first, the second, and the third sub-pixels are arranged to form a delta pattern. The first capacitor is disposed between the first and the second sub-pixels to compensate for the brightness shift of the first sub-pixel.

### BACKGROUND OF THE INVENTION

1. Field of the Invention

The invention relates to a display panel, and more particularly to a display panel comprising a plurality of sub-pixels, wherein the sub-pixels are arranged to form a plurality of delta patterns.

2. Description of the Related Art

Liquid crystal displays (LCD) are widely used as they possess the favorable advantages of thin profile, light weigh, and low radiation. An LCD comprises a display panel comprising a plurality of pixel units. Each pixel unit comprises three sub-pixels displaying red, blue, and green, respectively.

The three sub-pixels are arranged to form stripe patterns or triangle patterns also known as delta patterns. Notebooks or personal computers (PCs) frequently utilize display panels comprising stripe patterns. Because an image displayed by the display panel of a notebook or a PC comprises a plurality of block frames, the edges of the block frames are straight due to the stripe patterns.

Audio/video (AV) products frequently utilize delta patterns. Because images displayed by AV products are typically people, and the contours of people are not straight, the delta patterns are utilized for smoothing contours in displayed images.

The sub-pixels display the corresponding brightness according to gray levels. In an 8-bit display panel for example, the range of gray levels is 0˜255. FIG. 1a is a schematic diagram of an image displayed by a conventional display panel. When the original gray level of a sub-pixel R is 255, the original gray level of a sub-pixel G is 128, and the original gray level of a sub-pixel B is 0, the even rows may be less bright than the odd rows due to the gray level.

The gray level of the sub-pixel R and the gray level of the sub-pixel B are extreme values, when the shift occurs in the gray levels of the sub-pixels R and B, the changes in brightness for sub-pixels R and B are smaller. The gray level of the sub-pixel G, however, is close to a middle value. When the shift occurs in the gray levels of the sub-pixel G, the change in brightness of the sub-pixel G is greater. Thus, the even rows are darker than the odd rows due to the gray level.

FIG. 1b is a schematic of another image displayed by the conventional display panel. When the original gray level of a sub-pixel R is 0, the original gray level of a sub-pixel G is 128, and the original gray level of a sub-pixel B is 255, the even rows may be brighter than the odd rows due to the shift in gray levels. As shown in FIGS. 1a and 1b, the change in brightness of the sub-pixels RGB is greater because one of the gray levels of the sub-pixels RGB is close to the middle value and the others are close the maximum value and the minimum respectively.

When the gray levels of sub-pixels RGB are (255, 128, 0), (0, 128, 255), (128, 255, 0), (128, 0, 255), (0, 255, 128), and (255, 0, 128), the change in brightness of the sub-pixels RGB is greater. Because the sensitivity of a user is greater for green, when the gray levels of sub-pixels RGB are (255, 128, 0) or (0, 128, 255) and a shift occurs in the gray levels, changes in brightness are easily detectable.

### BRIEF SUMMARY OF THE INVENTION

The invention provides display panels. An exemplary embodiment of a display panel comprises a first sub-pixel, a second sub-pixel, a third sub-pixel, and a first capacitor. The first sub-pixel is coupled to a first gate line. The second sub-pixel is coupled to a second gate line. The third sub-pixel is coupled to the second gate line. The first, second, and third sub-pixels are arranged to form a delta pattern. The first capacitor is disposed between the first and the second sub-pixels to compensate for the brightness shift of the first sub-pixel.

Electronic systems are also provided. An exemplary embodiment of an electronic system comprises a power connector and a display panel. The power connector receives a power signal. The display panel powered by the power signal comprises a first sub-pixel, a second sub-pixel, a third sub-pixel, and a first capacitor and displays images. The first sub-pixel is coupled to a first gate line. The second sub-pixel is coupled to a second gate line. The third sub-pixel is coupled to the second gate line. The first, second, and third sub-pixels are arranged to form a delta pattern. The first capacitor is disposed between the first and the second sub-pixels to compensate for the shift in brightness of the first sub-pixel.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1a is a schematic of an image displayed by a conventional display panel;

FIG. 1b is a schematic of another image displayed by the conventional display panel;

FIG. 2 is a schematic diagram of an exemplary embodiment of an electronic system;

FIG. 3 is a schematic diagram of an exemplary embodiment of a display panel; and

FIG. 4 is a schematic diagram of an exemplary embodiment of the sub-pixels G23, B33, R34, B24, and G43.

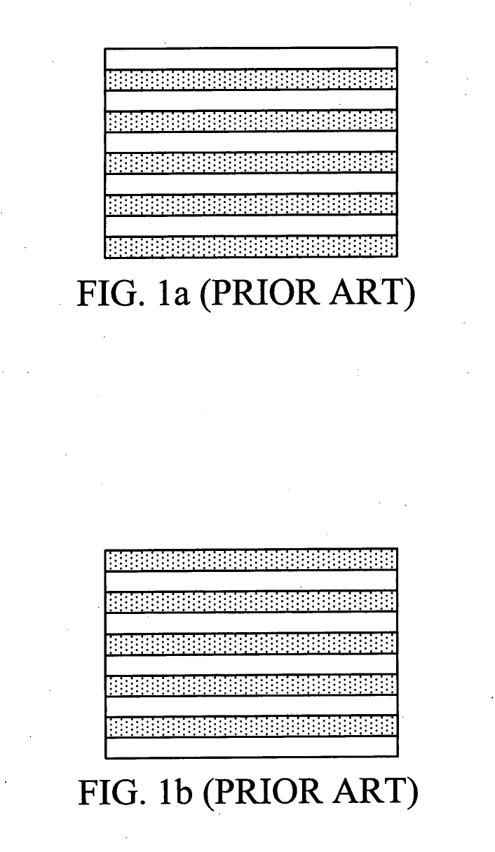

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

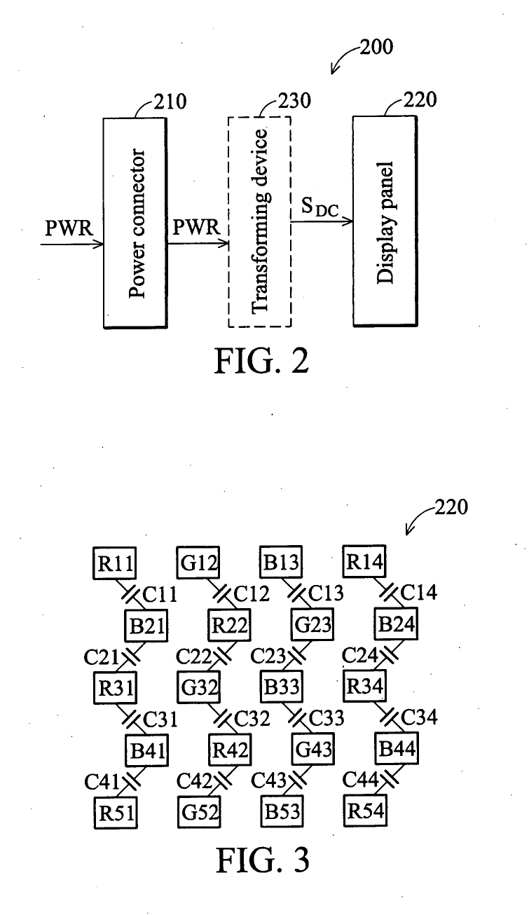

FIG. 2 is a schematic diagram of an exemplary embodiment of an electronic system. Electronic system 200 is a personal digital assistant (PDA), a cellular phone, a notebook or a PC and comprises a power connector 210 and a display panel 220.

Power connector 210 receives a power signal PWR. Display panel 220, when powered by power signal PWR, displays an image. In this embodiment, electronic system 200 further comprises a transforming device 230. When the power signal PWR is an alternating current (AC) signal, transforming device 230 transforms the power signal PWR into a direct current (DC) signal SDC. In some embodiments, if the power signal PWR is provided by a battery, transforming device 230 is omitted and the power signal PWR is directly provided to display panel 220.

FIG. 3 is a schematic diagram of an exemplary embodiment of a display panel. Display panel 220 comprises sub-pixels R11, G12, B13, . . . , and R54 and capacitors C11˜C44. All sub-pixels are arranged to form a plurality of delta patterns. Capacitors C11˜C44 are coupled between two sub-pixels for compensating the brightness of the corresponding sub-pixel.

Sub-pixels R11, R14, R22, . . . , and R54 display red. Sub-pixels G12, G23, . . . , and G52 display green. Sub-pixels B13, B21, . . . , and B53 display blue. In this embodiment, a delta pattern is formed by sub-pixels G23, B33, and R34. Capacitor C23 is disposed between sub-pixels G23 and B33. In some embodiments, another delta pattern is formed by sub-pixels G23, B24, and R34. Capacitor C24 is disposed between sub-pixels B24 and R34. Another delta pattern is formed by sub-pixels B33, R34, and G43. Capacitor C33 is disposed between sub-pixels B33 and G43.

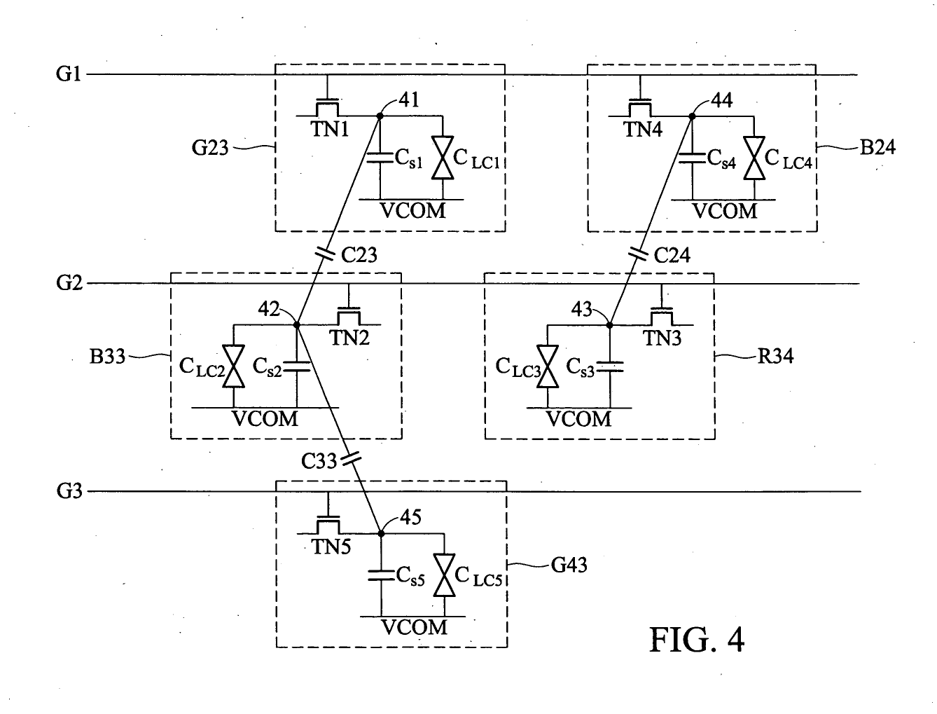

Only sub-pixels G23, B33, R34, B24, and G43 are described herein as an example because description thereof is identical to sub-pixels R11, G12, B13, . . . , and R54. FIG. 4 is a schematic diagram of an exemplary embodiment of the sub-pixels G23, B33, R34, B24, and G43. Sub-pixel G23 is coupled to a gate line G1. Sub-pixels B33 and R34 are coupled to a gate line G2. Sub-pixels G23, B33, and R34 are arranged to form a delta pattern. Capacitor C23 is disposed between sub-pixels G23 and B33 to compensate for the shift in brightness of the sub-pixel.

For example, when gate line G1 is turned on before than gate line G2, capacitor C23 compensates the brightness shift of the sub-pixel G23. When gate line G2 is turned on before than gate line G1, capacitor C23 compensates the brightness shift of the sub-pixel B33.

Sub-pixel G23 comprises a transistor TN1, a storage capacitor Cs1 and a liquid crystal capacitor CLC1. Transistor TN1 is connected to storage capacitor Cs1 in serial between gate line G1 and common level VCOM. Liquid crystal capacitor CLC1 is connected to storage capacitor Cs1 in parallel between a point 41 and common level VCOM.

Sub-pixel B33 comprises a transistor TN2, a storage capacitor Cs2 and a liquid crystal capacitor CLC2. Transistor TN2 is connected to storage capacitor Cs2 in serial between gate line G2 and common level VCOM. Liquid crystal capacitor CLC2 is connected to storage capacitor Cs2 in parallel between a point 42 and common level VCOM.

Transistor TN1 and storage capacitor Cs1 are coupled to point 41. Transistor TN2 and storage capacitor Cs2 are coupled to point 42. Capacitor C23 is coupled between points 41 and 42. If gate lines G1 and G2 are sequentially turned on, the brightness shift of sub-pixel G23 is compensated by capacitor C23.

If the gray level of sub-pixels R34, G23, and B33 is (255, 128, 0) the gray level of sub-pixel G23 is close to a middle value, when a shift occurs in the gray level of sub-pixel G23, the change in brightness of the sub-pixel G23 is greater.

In this embodiment, if the display panel is in a normal white mode, the difference between a voltage corresponding to the gray level of sub-pixel B33 and the common level VCOM is a maximum value. Thus, capacitor C23 is disposed between sub-pixels. G23 and B33 to compensate for the shift in brightness of sub-pixel G23 according to the difference.

In some embodiments, if display panel is in a normal black mode, the difference between a voltage corresponding to the gray level of sub-pixel R34 and the common level VCOM is a maximum value. A capacitor is disposed between sub-pixels G23 and R34 to compensate for the shift in brightness of sub-pixel G23 according to the difference.

A delta pattern is formed by sub-pixels B24, G23, and R34. Capacitor C24 is disposed between sub-pixels B24 and R34. Sub-pixels B24 and B33 display blue.

Sub-pixel R34 comprises a transistor TN3, a storage capacitor Cs3 and a liquid crystal capacitor CLC3. Transistor TN3 is connected to storage capacitor Cs3 in serial between gate line G2 and common level VCOM. Liquid crystal capacitor CLC3 is connected to storage capacitor Cs3 in parallel between a point 43 and common level VCOM.

Sub-pixel B24 comprises a transistor TN4, a storage capacitor Cs4 and a liquid crystal capacitor CLC4. Transistor TN4 is connected to storage capacitor Cs4 in serial between gate line G1 and common level VCOM. Liquid crystal capacitor CLC4 is connected to storage capacitor Cs4 in parallel between a point 44 and common level VCOM.

Transistor TN3 and storage capacitor Cs3 are coupled to point 43. Transistor TN4 and storage capacitor Cs4 are coupled to point 44. Capacitor C24 is coupled between points 43 and 44. If gate lines G1 and G2 are sequentially turned on, the brightness shift of sub-pixel B24 is compensated by capacitor C24.

Assuming the gray level of sub-pixels R34, G23, and B24 is (0, 255, 128). Because the gray level of sub-pixel B24 is close to a middle value, when a shift occurs in the gray level of sub-pixel B24, the change in brightness of the sub-pixel B24 is greater.

In this embodiment, if display panel is a normal white mode, the difference between a voltage corresponding to the gray level of sub-pixel R34 and the common level VCOM is a maximum value. Capacitor C24 is disposed between sub-pixels R34 and B24 to compensate for the shift in brightness of sub-pixel B24 according to the difference.

A delta pattern is formed by sub-pixels B33, R34, and G43. Capacitor C33 is disposed between sub-pixels B33 and G43. Sub-pixels G43 and G23 display green.

Sub-pixel G43 comprises a transistor TN5, a storage capacitor Cs5 and a liquid crystal capacitor CLC5. Transistor TN5 is connected to storage capacitor Cs5 in serial between a gate line G3 and common level VCOM. Liquid crystal capacitor CLC5 is connected to storage capacitor Cs5 in parallel between a point 45 and common level VCOM.

Transistor TN5 and storage capacitor Cs5 are coupled to point 45. Capacitor C33 is coupled between points 42 and 45. Because gate lines G1 and G2 are sequentially turned on, the brightness shift of sub-pixel B33 is compensated by capacitor C33.

Assuming the gray level of sub-pixels R34, G43, and B33 is (255, 0, 128). Because the gray level of sub-pixel B33 is close to a middle value, when a shift occurs in the gray level of sub-pixel B33, the change in brightness of the sub-pixel B33 is greater.

In this embodiment, if the display panel is a normal white mode, the difference between a voltage corresponding to the gray level of sub-pixel G43 and the common level VCOM is a maximum value. Thus, capacitor C33 is disposed between sub-pixels B33 and G43 to compensate for the shift in brightness of sub-pixel B33 according to the difference.

Additionally, assuming the display panel is a normal white mode, the gray level of sub-pixel R34 is 255, the gray level of sub-pixels G23 and G43 is 0, and the gray level of sub-pixels B24 and B33 are 128. Because the difference between a voltage corresponding to the gray level of sub-pixel G23 and the common level VCOM is a maximum value, when a shift occurs in the gray level of sub-pixel G23, the change in brightness of the sub-pixel G23 is less. Although the gray level of sub-pixel G23 is compensated by capacitor C23, the compensation effect is less.

Because the gray level determines the brightness of the sub-pixel, when the shift occurs in the gray level of the sub-pixel, the brightness of the sub-pixel is affected. Thus, a capacitor is disposed between two sub-pixels to compensate for the shifted gray level such that the sub-pixel displays the smooth brightness.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display panel, comprising:
a first sub-pixel coupled to a first gate line;
a second sub-pixel coupled to a second gate line;
a third sub-pixel coupled to the second gate line, wherein the first, the second, and the third sub-pixels are arranged to form a delta pattern; and
a first capacitor disposed between the first and the second sub-pixels to compensate for the brightness shift of the first sub-pixel.

2. The display panel as claimed in claim 1, wherein the first sub-pixel comprises a first transistor and a first storage capacitor connected to the first transistor in serial between the first gate line and a common level, and the second sub-pixel comprises a second transistor and a second storage capacitor connected to the second transistor in serial between the second gate line and the common level.

3. The display panel as claimed in claim 2, wherein the first transistor is coupled to the first storage capacitor at a first point and the second transistor is coupled to the second storage capacitor at a second point.

4. The display panel as claimed in claim 3, wherein the first capacitor is coupled between the first and the second points.

5. The display panel as claimed in claim 2, further comprising:
a fourth sub-pixel, wherein the first, the third, and the fourth sub-pixels are arranged to form another delta pattern; and
a second capacitor disposed between the third and the fourth sub-pixels.

6. The display panel as claimed in claim 5, wherein the second and the fourth sub-pixels display the same color.

7. The display panel as claimed in claim 6, wherein the third sub-pixel comprises a third transistor and a third storage capacitor connected to the third transistor in serial between the second gate line and the common level and the fourth sub-pixel comprises a fourth transistor and a fourth storage capacitor connected to the fourth transistor in serial between the first gate line and the common level.

8. The display panel as claimed in claim 7, wherein the third transistor is coupled to the third storage capacitor at a third point and the fourth transistor is coupled to the fourth storage capacitor at a fourth point.

9. The display panel as claimed in claim 8, wherein the second capacitor is coupled between the third and the fourth points.

10. The display panel as claimed in claim 2, further comprising:
a fifth sub-pixel, wherein the second, the third, and the fifth sub-pixels are arranged to form another delta pattern; and
a third capacitor disposed between the second and the fifth sub-pixels.

11. The display panel as claimed in claim 10, wherein the first and the fifth sub-pixels display the same color.

12. The display panel as claimed in claim 11, wherein the fifth sub-pixel comprises a fifth transistor and a fifth storage capacitor connected to the fifth transistor in serial between a third gate line and the common level.

13. The display panel as claimed in claim 12, wherein the first, the second, and the third gate lines are sequentially turned on.

14. The display panel as claimed in claim 12, wherein the fifth transistor and the fifth storage capacitor are coupled to a fifth point.

15. The display panel as claimed in claim 14, wherein the third capacitor is coupled between the second and the fifth points.

16. An electronic system, comprising:
a power connector receiving a power signal; and
